(19) United States
(12) Patent Application Publication
(10) Pub. No.: US 2025/0291090 A1
(43) Pub. Date: Sep. 18, 2025

(54) POLARIZER, METHOD OF MANUFACTURING POLARIZER, AND OPTICAL DEVICE

(71) Applicant: Dexerials Corporation, Shimotsuke-Shi (JP)

(72) Inventor: Takanori Sato, Shimotsuke-shi (JP)

(73) Assignee: Dexerials Corporation, Shimotsuke-Shi (JP)

(21) Appl. No.: 19/067,186

(22) Filed: Feb. 28, 2025

(30) Foreign Application Priority Data
Mar. 15, 2024 (JP) 2024-041669

(51) Int. Cl. G02B 1/18; G02B 5/30

(52) U.S. Cl. CPC G02B 1/18; G02B 5/3025

(57) ABSTRACT

Provided is a polarizer comprising: a transparent substrate; and lattice protrusions that are arranged on one surface of the transparent substrate at a pitch shorter than a wavelength of light in an allocated band and that extend in a predetermined direction. The lattice protrusions each comprise, in order from the transparent substrate: a reflective layer; a dielectric layer; and an absorption layer; and a water repellent film on which areas treated with a plurality of different water-repellent treatment agents exist non-uniformly is formed on surfaces of the lattice protrusions and a surface of the transparent substrate on which the lattice protrusions are arranged.

This application is based on and claims the benefit of priority from Japanese Patent Application No. 2024-041669, filed on 15 Mar. 2024, the content of which is incorporated herein by reference.

### BACKGROUND OF THE INVENTION

### Field of the Invention

The present invention relates to a polarizer, a method of manufacturing a polarizer, and an optical device.

### Related Art

In recent years, instead of organic polarizers, inorganic polarizers have begun to be employed in optical devices such as liquid crystal projectors which require heat resistance. Among inorganic polarizers, a wire-grid type polarizer that includes lattice protrusions including, in order from the side of a transparent substrate: a reflective layer; a dielectric layer; and an absorption layer has high heat resistance. Accordingly, the wire-grid type polarizer is often used for liquid crystal projector applications. The lattice protrusions are arranged on one surface of the transparent substrate at a pitch shorter than the wavelength of light in an allocated band, and extend in a predetermined direction. The lattice protrusions are formed by, for example, forming the reflective layer, the dielectric layer, and the absorption layer by a physical film deposition method, and subsequently, selectively etching them by a photolithography method and a dry etching method.

On the other hand, on the polarizer, a water repellent film is formed so as to cover the lattice protrusions in order to avoid degradation of optical characteristics and appearance quality due to adhesion of moisture and dust in the atmosphere causing stains. Here, the water repellent film requires oil repellency in addition to water repellency.

Patent Document 1 describes that a protective film is formed on the surfaces of the lattice protrusions and the surfaces of the bottoms of grooves formed between the lattice protrusions. Here, the protective film includes: a first protective film formed so as to cover the surface of the reflective layer; a second protective film that is formed so as to cover the surfaces of the bottom portions of the grooves, and is made up of an organic film; and a third protective film that is formed so as to cover the surface of the absorption layer, and is made up of an organic film.
Patent Document 1: Japanese Unexamined Patent Application, Publication No. 2020-64326

### SUMMARY OF THE INVENTION

Here, in liquid crystal projector applications, the water repellent film requires heat resistance. It is, however, difficult to simultaneously achieve both the oil repellency and the heat resistance of the water repellent film.

The present invention has an object to provide a polarizer that can simultaneously achieve both the oil repellency and heat resistance of a water repellent film.

A first aspect of the present invention relates to a polarizer, including: a transparent substrate; and lattice protrusions that are arranged on one surface of the transparent substrate at a pitch shorter than a wavelength of light in an allocated band and that extend in a predetermined direction. The lattice protrusions each include, in order from the transparent substrate: a reflective layer; a dielectric layer; and an absorption layer. On surfaces of the lattice protrusions and a surface of the transparent substrate on which the lattice protrusions are arranged, a water repellent film on which areas treated with a plurality of different water-repellent treatment agents exist non-uniformly is formed.

A second aspect of the present invention relates to the polarizer according to the first aspect, in which the plurality of different water-repellent treatment agents include a first water-repellent treatment agent that contains a perfluoroalkyl group, and a second water-repellent treatment agent that does not contain a perfluoroalkyl group.

A third aspect of the present invention relates to the polarizer according to the second aspect, in which the first water-repellent treatment agent is trichloro(1H,1H,2H,2H-perfluoro-n-octyl)silane, and the second water-repellent treatment agent is dimethyldichlorosilane.

A fourth aspect of the present invention relates to a method of manufacturing the polarizer according to any one of the first to third aspects, the method including: a step of stacking, in order from the transparent substrate: a reflective layer; a dielectric layer; and an absorption layer, on one surface of the transparent substrate to form a stack; a step of forming lattice protrusions by selectively etching the stack; and a step of treating the surfaces of the lattice protrusions and the surface of the transparent substrate on which the lattice protrusions are formed, with a plurality of different water-repellent treatment agents to form the water repellent film.

A fifth aspect of the present invention relates to the method of manufacturing the polarizer according to the fourth aspect, in which a part the surfaces of the lattice protrusions and the surface of the transparent substrate on which the lattice protrusions are formed are alternately treated with the plurality of different water-repellent treatment agents, to form the water repellent film.

A sixth aspect of the present invention relates to an optical device, including the polarizer according to any one of the first to third aspects.

With the present invention, a polarizer that can simultaneously achieve both the oil repellency and heat resistance of the water repellent film can be provided.

### BRIEF DESCRIPTION OF THE DRAWINGS

FIG. 1 is a perspective schematic view showing a polarizer according to one embodiment of the present invention;

FIG. 2 is a schematic sectional view showing the polarizer in FIG. 1;

FIG. 3 is a graph showing the relationship between the amount of treatment with FOTS, and the contact angle with water in Comparative Example 1;

FIG. 4 is a graph showing the relationship between the amount of treatment by DDMS, and the contact angle with water in Comparative Example 2;

FIG. 5 is a schematic diagram illustrating a method of evaluating the oil repellency of a water repellent film in an Example;

FIG. 6 is a graph showing evaluation results of the oil repellencies of the water repellent films of the polarizers in Example 1, and Comparative Examples 1 and 2; and

FIG. 7 is a graph showing evaluation results of the heat resistances of the water repellent films of the polarizers in Example 1, and Comparative Examples 1 and 2.

### DETAILED DESCRIPTION OF THE INVENTION

Hereinafter, an embodiment of the present invention is described with reference to the drawings.

### [Polarizer]

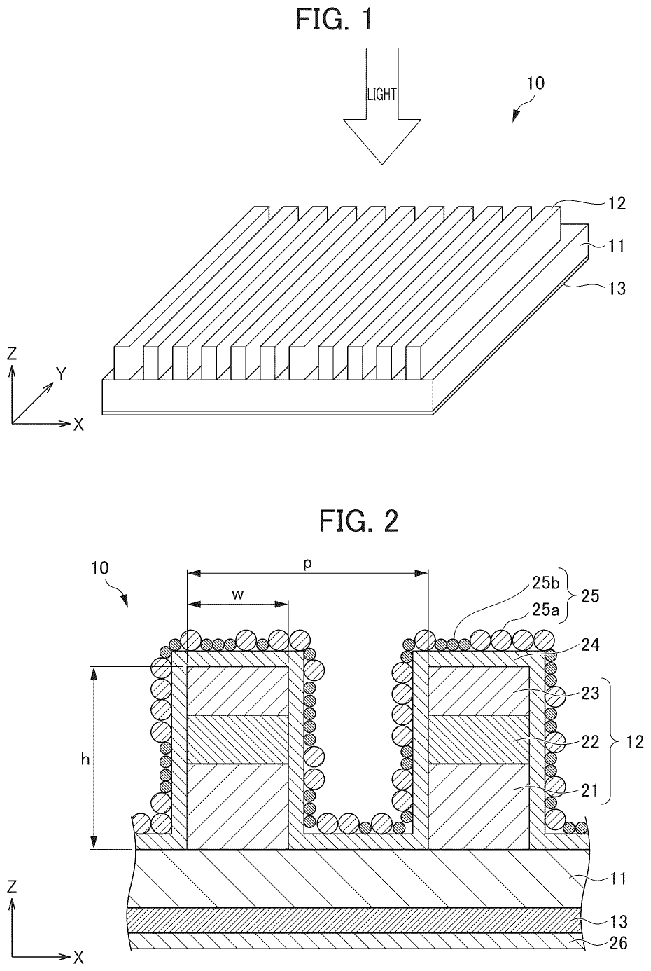

FIG. 1 shows a polarizer according to one embodiment of the present invention.

The polarizer 10 includes: a transparent substrate 11; and lattice protrusions 12 that are arranged on one surface of the transparent substrate 11 at a pitch shorter than the wavelength of light in an allocated band, and extend in a predetermined direction. The polarizer 10 further includes an anti-reflective layer 13 on the opposite surface of the transparent substrate 11.

Here, the direction in which the lattice protrusions 12 extend is called a Y-axis direction. Furthermore, a direction which is orthogonal to the Y-axis direction and on which the lattice protrusions 12 are arranged along the principal surface of the transparent substrate 11 is called an X-axis direction. Moreover, a direction orthogonal to the Y-axis direction and the X-axis direction, i.e., a direction perpendicular to the principal surface of the transparent substrate 11 is called a Z-axis direction. Note that a direction in which light enters the polarizer 10 is the Z-axis direction. Preferably, light is incident on the surface of the polarizer 10 where the lattice protrusions 12 are formed.

Through use of four processes of selective light absorption of polarized waves due to transmission, reflection, interference, and optical anisotropy, the polarizer 10 attenuates polarized waves (TE waves (S waves)) having an electric field component parallel to the Y-axis direction, and transmits polarized waves (TM waves (P waves)) having an electric field component parallel to the X-axis direction. Consequently, the Y-axis direction is the absorption axis of the polarizer 10, and the X-axis direction is the transmission axis of the polarizer 10.

As shown in FIG. 2, the lattice protrusions 12 each include, in order from the transparent substrate 11: a reflective layer 21; a dielectric layer 22; and an absorption layer 23. Here, the lattice protrusions 12 has a wire-grid structure arranged to form a one-dimensional lattice. On the polarizer 10, the surfaces of the lattice protrusions 12 and the surface of the transparent substrate 11 on which the lattice protrusions 12 are arranged are covered with a protective film 24. Accordingly, the heat resistance of the polarizer 10 is improved. As for the polarizer 10, a water repellent film 25 on which areas treated with a first water-repellent treatment agent 25a, and areas treated with a second water-repellent treatment agent 25b non-uniformly reside is formed on the surface of the protective film 24. Accordingly, both the oil repellency and the heat resistance of the water repellent film 25 are simultaneously achieved. Furthermore, the polarizer 10 includes, in order from the transparent substrate 11: the anti-reflective layer 13; and a protective film 26, on the other surface of the transparent substrate 11.

The first water-repellent treatment agent 25a is not specifically limited as long as the oil repellency of the water repellent film 25 can be improved. For example, a silane coupling agent containing a perfluoroalkyl group, such as trichloro(1H,1H,2H,2H-perfluoro-n-octyl)silane, may be adopted. Two or more types may be used together. The carbon number a perfluoroalkyl group included in a first silane coupling agent is not specifically limited. For example, the number ranges from four to eight, inclusive. The number of hydrolyzable groups included in the first silane coupling agent is not specifically limited. For example, the number ranges from 2 to 3, inclusive. Although not specifically limited, the hydrolyzable group may be, for example, a chloro group, an alkoxy group, or a hydroxyl group.

A second water-repellent treatment agent 25b is not specifically limited as long as the heat resistance of the water repellent film 25 can be improved. For example, the agent may be a silane coupling agent containing no perfluoroalkyl group, such as dimethyldichlorosilane. Two or more types may be used together. The carbon number of an alkyl group included in a second silane coupling agent is not specifically limited. For example, the number ranges from 2 to 12, inclusive. The number of hydrolyzable groups included in the second silane coupling agent is not specifically limited. For example, the number ranges from 2 to 3, inclusive. Although not specifically limited, the hydrolyzable group may be, for example, a chloro group, an alkoxy group, or a hydroxyl group.

The method of forming the water repellent film 25 is not specifically limited. For example, the method may be a CVD (Chemical Vapor Deposition) method, an ALD (Atomic Layer Deposition) method, or an application method.

Note that as required, in the polarizer 10, at least one selected from the anti-reflective layer 13, the protective film 24, and the protective film 26 may be omitted.

Light incident on the surface of the polarizer 10 on which the lattice protrusions 12 are formed is partially absorbed while passing through the absorption layer 23 and the dielectric layer 22, and is attenuated. Polarized waves (TE waves (P waves)) of the light having passed through the absorption layer 23 and the dielectric layer 22 transmit the reflective layer 21 with high transmittance. On the other hand, polarized waves (TE waves (S waves)) of the light having passed through the absorption layer 23 and the dielectric layer 22 are reflected by the reflective layer 21. The TE waves reflected by the reflective layer 21 are partially absorbed while passing through the dielectric layer 22 and the absorption layer 23, but are partially reflected and returned to the reflective layer 21. The TE waves reflected by the reflective layer 21 interfere while passing through the dielectric layer 22 and the absorption layer 23, and are attenuated. As described above, the selective attenuation of the TE waves allows the polarizer 10 to achieve desired polarization characteristics.

Here, referring to FIG. 2, the dimensions of the lattice protrusions 12 are described. The height h of the lattice protrusions 12 means the dimension of each lattice protrusion 12 in the Z-axis direction. The width w of each lattice protrusion 12 means the dimension of the lattice protrusion 12 in the X-axis direction. The pitch p of the lattice protrusions 12 means the repetitive interval of the lattice protrusions 12 in the X-axis direction.

The pitch p of the lattice protrusions 12 is not specifically limited as long as the pitch p is shorter than the wavelength of light in an allocated band. However, in view of ease of manufacture and stability of the polarizer 10, it is preferable that the pitch p range from 100 nm to 200 nm, inclusive. Note that by observation with a scanning electron microscope or a transmission electron microscope, the pitch p of the lattice protrusions 12 can be measured. The pitch p of the lattice protrusions 12 is, for example, the arithmetic mean value of measurements at four freely selected points. Hereinafter, such a measurement method is called electron microscopy.

### (Transparent Substrate)

The transparent substrate 11 is not specifically limited as long as this substrate is transparent to light in an allocated band. The substrate can be selected as appropriate for the purpose. The light in the allocated band is not specifically limited. For example, visible light having a wavelength ranging from 400 nm to 700 nm, inclusive.

Note that “transparent to light in an allocated band” means that the light has a transmittance capable of maintaining the function as a polarizer, and does not mean that the transmittance of light in the allocated band is 100%.

The shape of the principal surface of the transparent substrate 11 is not specifically limited. For example, the shape may be a rectangular shape. The average thickness of the transparent substrate 11 is not specifically limited. For example, the average thickness ranges from 0.3 mm to 1 mm, inclusive.

Preferably, the transparent substrate 11 is made of a material having a refractive index ranging from 1.1 to 2.2, inclusive. The material having a refractive index ranging from 1.1 to 2.2, inclusive is not specifically limited. For example, the material is glass, quartz crystal, quartz, or sapphire. Preferably, in view of the cost and transmittance, the material is glass, such as silicate glass, among them. Particularly preferably, the material is any of quartz having a refractive index of 1.46, and soda-lime glass having a refractive index of 1.51. In view of the thermal conductivity, it is preferable that the material be any of quartz crystal and sapphire. Accordingly, the heat resistance of the transparent substrate 11 can be improved, which allows use in liquid crystal projector applications.

Note that in a case of using optically active crystal, such as quartz crystal or sapphire, as a material forming the transparent substrate 11, it is preferable to arrange lattice protrusions 12 in a direction parallel or perpendicular to the optical axis of the crystal. Accordingly, excellent optical characteristics can be achieved. Here, the optical axis of the crystal is a direction axis that minimizes the difference in refractive index between ordinary rays (O-rays) and extraordinary rays (E-rays) of light traveling in the direction.

### (Reflective Layer)

The reflective layer 21 is deposited on one side of the transparent substrate 11, and makes up part of the lattice protrusions 12 extending in the Y-axis direction. The reflective layer 21 attenuates polarized waves (TE waves (S waves)) having an electric field component in the Y-axis direction, while transmitting the polarized wave (TE waves (P waves)) having an electric field component in the X-axis direction.

The thickness of the reflective layer 21 is not specifically limited. For example, the thickness ranges from 100 nm and 300 nm, inclusive. Note that the thickness of the reflective layer 21 is measured by, for example, electron microscopy.

The material forming the reflective layer 21 is not specifically limited as long as this layer can reflect light in the allocated band. For example, the material forming the reflective layer 21 is any of simple substances of elements, such as Al, Ag, Cu, Mo, Cr, Ti, Ni, W, Fe, Si, Ge, Te, and Nd, and any of alloys each containing one of more of these elements. Preferably, the material is aluminum or an aluminum alloy among them. Note that the reflective layer 21 may be, for example, an inorganic film or a resin film that is other than metal, and has a surface reflectance improved by coloration.

The method of depositing the reflective layer 21 is not specifically limited. For example, the method may be a deposition method or a sputtering method.

Note that the reflective layer 21 may be a stack where layers made of different materials are stacked together.

### (Dielectric Layer)

The dielectric layer 22 is deposited on the surface of the reflective layer 21, and makes up part of the lattice protrusions 12 extending in the Y-axis direction. The thickness of the dielectric layer 22 is formed in a range that allows the phase of polarized light having passed through the absorption layer 23 and been reflected by the reflective layer 21 to deviate by half a wavelength from that of polarized light having passed through the absorption layer 23.

Specifically, the thickness of the dielectric layer 22 may be set as appropriate in a range from 1 nm to 500 nm, inclusive, which can adjust the phase of the polarized light and improve the interference effect. The thickness of the dielectric layer 22 is measured by, for example, electron microscopy.

The material forming the dielectric layer 22 are not specifically limited. For example, the material may be, any of silicon oxide such as SiO₂, Al₂O₃, beryllium oxide, metal oxide such as bismuth oxide, MgF₂, cryolite, germanium, titanium dioxide, silicon, magnesium fluoride, boron nitride, boron oxide, tantalum oxide, or carbon; two or more of them may be used together. Preferably, the material is any of silicon oxide and titanium oxide among them.

Preferably, the refractive index of the dielectric layer 22 is higher than 1.0 and equal to or lower than 2.5. The optical characteristics of the reflective layer 21 are affected by the refractive index therearound. Accordingly, by selecting the material forming the dielectric layer 22, the optical characteristics of the polarizer 10 can be controlled. By adjusting the thickness and refractive index of the dielectric layer 22 as appropriate, TE waves reflected by the reflective layer 21 can be partially reflected by the absorption layer 23 and returned to the reflective layer 21 when the waves pass through the absorption layer 23, and the TE waves passing through the absorption layer 23 can be attenuated by interference. By selectively attenuating the TE waves as described above, desired polarization characteristics can be achieved.

The method of depositing the dielectric layer 22 is not specifically limited. For example, the method may be any of a deposition method, a sputtering method, a CVD (Chemical Vapor Deposition) method, and an ALD (Atomic Layer Deposition) method.

Note that the dielectric layer 22 may be a stack where layers made of different materials are stacked together.

### (Absorption Layer)

The absorption layer 23 is deposited on the surface of the dielectric layer 22, and makes up part of the lattice protrusions 12 extending in the Y-axis direction.

The thickness of the absorption layer 23 is not specifically limited. For example, the thickness ranges from 5 nm and 50 nm, inclusive. Note that the thickness of the absorption layer 23 is measured by, for example, electron microscopy.

The material forming the absorption layer 23 is not specifically limited as long as the layer can absorb light in the allocated band. The material may be, for example, a metal material, or a semiconductor material. The metal material is, for example, any of simple substances of elements, such as Ta, Al, Ag, Cu, Au, Mo, Cr, Ti, W, Ni, Fe, and Sn, and any of alloys each containing one or more of these elements. The semiconductor material is, for example, any of Si, Ge, Te, Zno, silicide materials (β-FeSi₂, MgSi₂, NiSi₂, BaSi₂, CrSi₂, CoSi₂, TaSi and the like). A material that contains Fe or Ta, and further contains Si is preferable among them.

In the case where a semiconductor material is used as the material forming the absorption layer 23, a semiconductor material having a bandgap energy equal to or lower than the energy of light in the allocated band is required to be employed. For example, in a case where the light in the allocated band is visible light, a semiconductor material having a bandgap energy equal to or lower than the energy of light having a wavelength of 400 nm, i.e., equal to or lower than 3.1 eV is required to be employed.

The method of depositing the absorption layer 23 is not specifically limited. For example, the method may be a deposition method or a sputtering method.

Note that the absorption layer 23 may be a stack where layers made of different materials are stacked together.

### (Anti-Reflective Layer)

The anti-reflective layer 13 is deposited on the other surface of the transparent substrate 11, and is, for example, a stack where low-refractive-index layers and high-refractive-index layers that have different refractive indices are stacked alternately.

The material forming the anti-reflective layer 13 is not specifically limited. For example, the material may be any of the silicon oxide, titanium oxide, zirconium oxide, aluminum oxide, niobium oxide, tantalum oxide, etc.

The thickness of the anti-reflective layer 13 is not specifically limited. For example, the thickness ranges from 1 nm to 500 nm, inclusive. The thickness of the anti-reflective layer 13 is measured by, for example, electron microscopy.

The method of depositing the anti-reflective layer 13 is not specifically limited. For example, the method may be any of a deposition method, a sputtering method, a CVD (Chemical Vapor Deposition) method, and an ALD (Atomic Layer Deposition) method. Among them, an IAD method (Ion-beam Assisted Deposition), which is ion-bean assisted, and an IBS method (Ion Beam Sputtering) are preferable.

### (Protective Film)

The protective film 24 is deposited on the surface of the transparent substrate 11 on which the lattice protrusions 12 are arranged, and the protective film 26 is deposited on the surface of the anti-reflective layer 13. The material forming the protective film 24 and the protective film 26 is similar to the material forming the dielectric layer 22 described above.

The method of depositing the protective film 24 and the protective film 26 is similar to the method of depositing the dielectric layer 22 described above.

Note that the protective film 24 and the protective film 26 are stacks in each of which layers made of different materials are stacked together.

### [Method of Manufacturing Polarizer]

Hereinafter, a method of manufacturing the polarizer 10 is described. First, in order from the transparent substrate 11, a reflective layer, a dielectric layer, and an absorption layer are stacked on one surface of the transparent substrate 11, thus forming a stack. Next, by selectively etching the stack, the lattice protrusions 12 are formed.

When the lattice protrusions 12 are formed, a one-dimensional lattice resist pattern is formed by, for example, a photolithography method, a nanoimprint method or the like, on the stack formed on one surface of the transparent substrate 11. Next, parts where no resist pattern is formed are selectively etched, thus forming the lattice protrusions 12. The etching method is not specifically limited. For example, the method may be a dry etching method using an etching gas that supports the etching target.

Next, the protective film 24 is deposited on the surfaces of the lattice protrusions 12, and the surface of the transparent substrate 11 on which the lattice protrusions 12 are formed, and subsequently, the surface of the protective film 24 is treated with the first water-repellent treatment agent and the second water-repellent treatment agent, thus forming the water repellent film 25.

The method of treating the surface of the protective film 24 with the first water-repellent treatment agent 25a and the second water-repellent treatment agent 25b is not specifically limited as long as the water repellent film 25 where areas treated with the first water-repellent treatment agent 25a, and areas treated with the second water-repellent treatment agent 25b are non-uniformly reside can be formed. For example, the method may be a method in which a part of the surface of the protective film 24 is alternately treated with the first water-repellent treatment agent 25a and the second water-repellent treatment agent 25b. In this case, the amount of treatment with the first water-repellent treatment agent 25a per time is not specifically limited. For example, the amount ranges from 1.7×10⁻⁵ mol/m² to 1.9×10⁻⁵ mol/m², inclusive. The amount of treatment with the second water-repellent treatment agent 25b per time is not specifically limited. For example, the amount ranges from 8.6×10⁻² mol/m² to 8.7×10⁻² mol/m², inclusive.

On the other hand, in order from the transparent substrate 11, the anti-reflective layer 13 and the protective film 26 are stacked on the other surface of the transparent substrate 11.

### [Optical Device]

The polarizer 10 is applicable to, for example, optical devices, such as a liquid crystal display, a liquid crystal projector, a head-up display, and a headlight of a vehicle. In particular, since the polarizer 10 is excellent in the heat resistance of the water repellent film 25, application to a liquid crystal projector is preferable.

Note that in a case where the optical device includes a plurality of polarizers, it is only required that at least one selected from the polarizers be the polarizer 10. For example, in a liquid crystal projector, it is only required that at least one selected from polarizers arranged on an entrance side and an exit side of a liquid crystal panel be the polarizer 10.

The embodiment of the present invention has thus been described above. However, the present invention is not limited to the embodiment described above. The embodiment described above may be changed as appropriate in a range of the spirit of the present invention.

### EXAMPLES

Next, an Example of the present invention is described. However, the present invention is not limited to this Example. Note that in the present Example, a test specimen simulating the polarizer 10 was used, and the water repellency of the water repellent film 25 was evaluated.

### Comparative Example 1

The surface of a silicon substrate was treated using the CVD method with trichloro(1H,1H,2H,2H-tridecafluoro-n-octyl)silane (FOTS), and a water repellent film was formed. Here, the amount of treatment with FOTS was 6.6×10⁻⁵ mol/m². The silicon substrate on which the water repellent film was formed had a contact angle with water of 106°. Note that the contact angle with water measured by the θ/2 method.

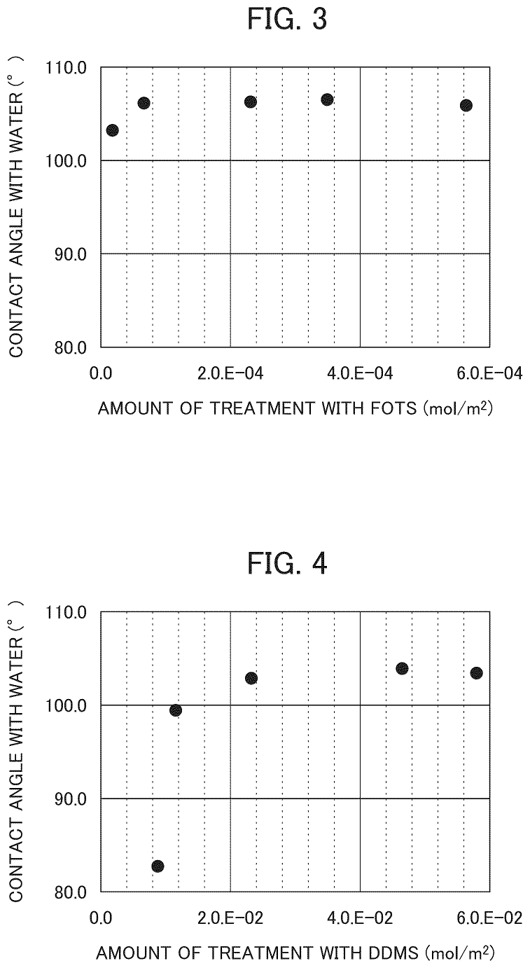

FIG. 3 shows the relationship between the amount of treatment with FOTS, and the contact angle with water. FIG. 3 shows that the contact angle with water increased with increase in the amount of treatment with FOTS, and the amount of treatment with FOTS was saturated when it reached 6.6×10⁻⁵ mol/m².

### Comparative Example 2

The surface of a silicon substrate was treated using the CVD method with dichlorodimethylsilane (DDMS), and a water repellent film was formed. Here, the amount of treatment by DDMS was 2.3×10⁻² mol/m². The silicon substrate on which the water repellent film was formed had a contact angle with water of 103°.

FIG. 4 shows the relationship between the amount of treatment by DDMS, and the contact angle with water. FIG. 4 shows that the contact angle with water increased with increase in the amount of treatment by DDMS, and the amount of treatment by DDMS was saturated when it reached 2.3×10⁻² mol/m².

### Example 1

A part of the surface of a silicon substrate was treated using the CVD method alternately with FOTS and DDMS, and a water repellent film was formed. Specifically, an operation including subjecting a part of the surface of the silicon substrate to a water-repellent treatment with FOTS, and subsequently subjecting the part of the surface of the silicon substrate to a water-repellent treatment with DDMS was repeated three times. Here, it was assumed that the amount of treatment with FOTS per time was 1.7×10⁻⁵ mol/m², and the amount of treatment with DDMS was 8.7×10⁻³ mol/m². The silicon substrate on which the water repellent film was formed had a contact angle with water of 105°, which was between the contact angle with water in Comparative Example 1 and the contact angle with water in Comparative Example 2.

Accordingly, it is estimated that the water repellent film on which areas treated with FOTS and areas treated with DDMS non-uniformly resided (present in a mixed manner) was formed.

### [Oil Repellency of Water Repellent Film]

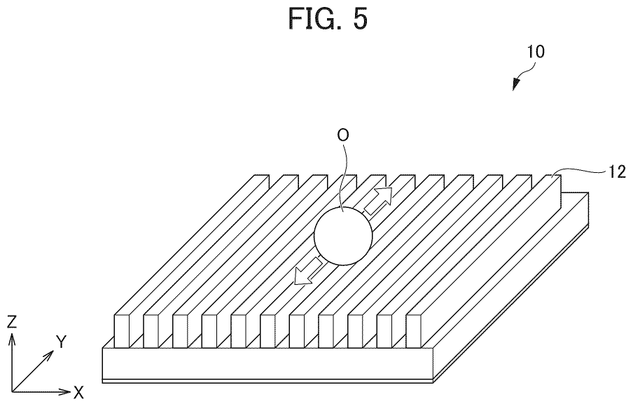

Polarizers 10 on which water repellent films 25 were formed under the same conditions as those in Example 1, and Comparative Examples 1 and 2 were used, and the oil repellency of each water repellent film 25 was evaluated. Specifically, oleic acid O was caused to adhere to a surface of the polarizer 10 on which the lattice protrusions 12 were formed, and the infiltration amount in the Y-axis direction was measured (see FIG. 5).

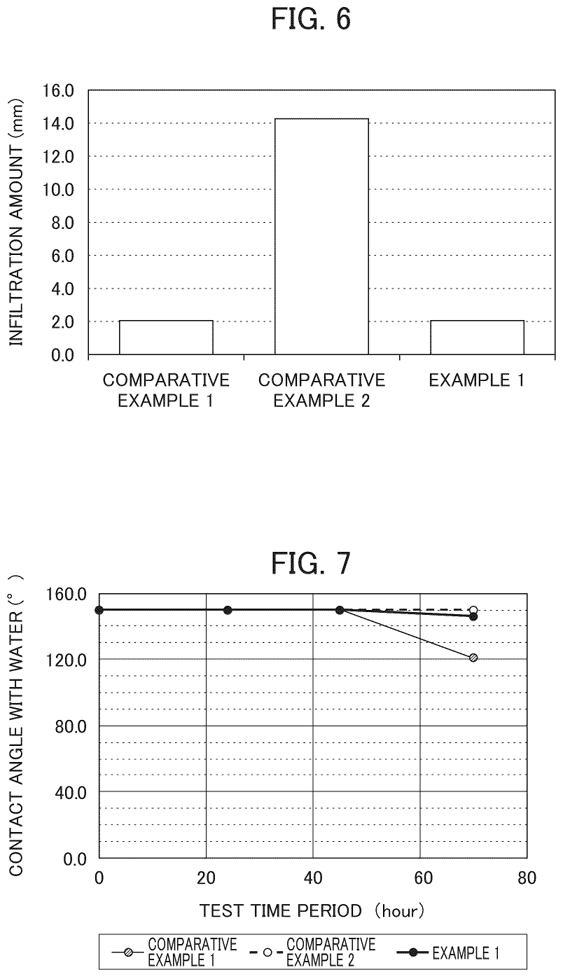

FIG. 6 shows evaluation results of the oil repellencies of the water repellent films of the polarizers in Example 1, and Comparative Examples 1 and 2.

FIG. 6 shows that the oil repellencies of the water repellent films of the polarizers in Example 1, and Comparative Example 1 were high. In contrast, in the polarizer in Comparative Example 2, the oil repellency of the water repellent film was low because the polarizer had not been treated with a silane coupling agent containing a perfluoroalkyl group.

### [Heat Resistance of Water Repellent Film]

Polarizers 10 on which water repellent films 25 were formed under the same conditions as those in Example 1, and Comparative Examples 1 and 2 were used, and the heat resistance of each water repellent film 25 was evaluated. Specifically, the polarizer 10 was kept in a clean oven at 350° C., and subsequently, the amount of change in the contact angle with water of the water repellent film 25 from an initial value was evaluated.

FIG. 7 shows evaluation results of the heat resistances of the water repellent films of the polarizers in Example 1, and Comparative Examples 1 and 2.

FIG. 7 shows that the heat resistances of the water repellent films of the polarizers in Example 1, and Comparative Example 2 were high. In contrast, in the polarizer in Comparative Example 1, the heat resistance of the water repellent film was low because the polarizer had not been treated with a silane coupling agent containing no perfluoroalkyl group.

### [Optical Characteristics]

Polarizers 10 on which water repellent films 25 were formed under the same conditions as those in Example 1, and Comparative Examples 1 and 2 were used, and the optical characteristics of each water repellent film 25 were evaluated. Specifically, the amount of change in the through-axis transmittance of the polarizer 10 before and after the water repellent film 25 was formed was evaluated. Note that the through-axis transmittance means the transmittance of polarized light (TM waves) in the X-axis direction entering the polarizer 10.

Table 1 shows evaluation results of the amounts of change in the through-axis transmittances [%] of the polarizers before and after the water repellent films were formed in Example 1, and Comparative Examples 1 and 2.

TABLE 1

| | Comparative | Comparative | |
|---|---|---|---|
| Wavelength Region | Example 1 | Example 2 | Example 1 |
| 430~510 nm | −0.07 | 0.15 | 0.18 |
| 520~590 nm | 0.01 | 0.17 | 0.19 |
| 600~680 nm | 0.03 | 0.08 | 0.17 |

Table 1 shows that the through-axis transmittance of the polarizer in Example 1 increased over the entire wavelength region from 430 to 680 nm. It is estimated that this is because the reflectance was reduced by reduction in the refractive index of the water repellent film 25 formed on the foremost surface of the polarizer 10.

Note that with the polarizer in Example 1, the change rate of the optical characteristics other than the through-axis transmittance was in an extent having no adverse effect on use.

### EXPLANATION OF REFERENCE NUMERALS

10 polarizer
11 transparent substrate
12 lattice protrusion
13 anti-reflective layer
21 reflective layer
22 dielectric layer
23 absorption layer
24, 26 protective film
25 water repellent film
25a first water-repellent treatment agent
25b second water-repellent treatment agent

What is claimed is:

1. A polarizer, comprising:
a transparent substrate; and
lattice protrusions that are arranged on one surface of the transparent substrate at a pitch shorter than a wavelength of light in an allocated band and that extend in a predetermined direction,
wherein the lattice protrusions each comprise, in order from the transparent substrate: a reflective layer; a dielectric layer; and an absorption layer; and
wherein a water repellent film on which areas treated with a plurality of different water-repellent treatment agents exist non-uniformly is formed on surfaces of the lattice protrusions and a surface of the transparent substrate on which the lattice protrusions are arranged.

2. The polarizer according to claim 1, wherein the plurality of different water-repellent treatment agents comprise a first water-repellent treatment agent that comprises a perfluoroalkyl group, and a second water-repellent treatment agent that does not comprise a perfluoroalkyl group.

3. The polarizer according to claim 2,
wherein the first water-repellent treatment agent is trichloro(1H,1H,2H,2H-perfluoro-n-octyl)silane, and
the second water-repellent treatment agent is dimethyldichlorosilane.

4. A method of manufacturing the polarizer according to claim 1, the method comprising:
stacking, in order from the transparent substrate: a reflective layer; a dielectric layer; and an absorption layer, on one surface of the transparent substrate to form a stack;
forming the lattice protrusions by selectively etching the stack; and
treating surfaces of the lattice protrusions and a surface of the transparent substrate on which the lattice protrusions are formed, with a plurality of different water-repellent treatment agents, to form the water repellent film.

5. The method of manufacturing the polarizer according to claim 4, wherein a part of the surfaces of the lattice protrusions and the surface of the transparent substrate on which the lattice protrusions are formed are alternately treated with the plurality of different water-repellent treatment agents to form the water repellent film.

6. An optical device, comprising the polarizer according to claim 1.
